(19) United States
(12) Patent Application Publication
(10) Pub. No.: US 2024/0422233 A1
(43) Pub. Date: Dec. 19, 2024

(54) MOBILITY IN SBA ACCESS NETWORK

(71) Applicant: Nokia Technologies Oy, Espoo (FI)

(72) Inventors: Thomas BELLING, Munich (DE); Bruno LANDAIS, Lannion (FR)

(21) Appl. No.: 18/700,809

(22) PCT Filed: Oct. 13, 2021
(86) PCT No.: PCT/EP2021/078316

§ 371 Date: Apr. 12, 2024

(51) Int. Cl. H04L 67/51; H04W 36/00

(52) U.S. Cl. CPC H04L 67/51; H04W 36/0064

(57) ABSTRACT

Method comprising: receiving, from a first network function of a first domain, a request for a first service related to one of one or more terminals or to one or more PDU sessions of the one or more terminals, identifying an address of one of one or more second network functions of a second domain based on the requested first service, the one or more terminals and the one ore more PDU sessions, respectively, and a first mapping relationship; forwarding the request or redirecting the request towards the one second network function, wherein the first mapping relationship indicates, for each of the one or more terminals and for each of the one or more PDU sessions, respectively, a respective address of the one second network function capable to serve the one or more terminals or the one or more PDU sessions.

### FIELD OF THE INVENTION

The present disclosure relates to a service-based architecture of an access network such as a radio access network.

### Abbreviations

3GPP 3^{rd} Generation Partnership Project
5G/6G/7G 5^{th}/6^{th}/7^{th} Generation
5GC 5G Core
5GS 5G System
AAA Authentication, Authorisation, Accounting
AF Application Function
AN Access Network
AMF Access and Mobility Management Function
API Application Programming Interface
AUSF Authentication Server Function
CM Connection Management
CN Core Network
DN Data Network
gNB next Generation NodeB
GUTI Globally Unique Temporary Identifier
HTTP Hypertext Transfer Protocol
ID Identifier
IE Information Element
LD Location Directory
LMF Location Management Function
MH Mobile Host
NAS Non-Access Stratum
NEF Network Exposure Function
NF Network Function
NG Next Generation
NGAP Next Generation Application Protocol
NRF Network Repository Function
NSSF Network Slice Selection Function
PCF Policy Control Function
PDU Protocol Data Unit
PSA PDU Session Anchor
RAN Radio Access Network
SB Service Based
SBA Service Based Architecture
SBI Service Based Interface
SCP Service Communication Proxy
SM Session Management
SMF Session Management Function
SMSF Short Message Service Function
SUPI Subscription Permanent Identifier
TS Technical Specification
UDM Unified Data Management
UDR Unified Data Repository
UDSF Unstructured Data Storage Function
UE User Equipment
UPF User Plane Function
URI Uniform Resource Identifier

### BACKGROUND

In the 5GC architecture, as specified in 3GPP TS 23.501, the AMF is located between the 5GC and the RAN. Towards the 5GC, it exhibits granular service-based HTTP based interfaces and can also use services offered by other core network functions.

However, towards the RAN, the AMF uses traditional non-service-based interfaces (N1, N2), as shown in FIG. 1.

All communication between RAN and 5GC needs to traverse the AMF. The AMF shields mobility of the UE and related handovers between RAN nodes from the 5GC.

For security reasons, the AMF also hides the permanent UE identifier (SUPI) used in the 5GC from RAN nodes and instead assigns a temporary and changeable “AMF UE NGAP ID” for the purpose of identifying a UE in communication with RAN nodes.

The AMF also sets up or releases N2 associations with RAN nodes when the UE transitions from CM-IDLE to CM-CONNECTED and vice versa. A UE is considered as idle (CM-IDLE) if it does not have a signaling connection with the access network.

FIGS. 2 to 6 (taken from 3GPP TS 23.502) show related existing procedures:

FIG. 2 shows PDU Session establishment. The AMF/NAS handler is aware of PDU sessions and SMFs serving them. Basically, the procedure shown in FIG. 2 works as follows:

The procedure assumes that the UE has already registered on the AMF.
1. In order to establish a new PDU Session, the UE generates a new PDU Session ID. The UE initiates the UE Requested PDU Session Establishment procedure by the transmission of a NAS message containing a PDU Session Establishment Request.
2. The AMF determines that the message corresponds to a request for a new PDU Session and selects a SMF.
3. AMF sends Nsmf_PDUSession_CreateSMContext Request to the selected SMF.
4. If Session Management Subscription data for corresponding SUPI, DNN and S-NSSAI of the HPLMN is not available, then SMF retrieves the Session Management Subscription data from UDM.
5. The SMF creates an SM context and responds to the AMF by providing an SM Context ID.
6. If the SMF needs to perform secondary authentication/authorization during the establishment of the PDU Session by a DN-AAA server, secondary authentication/authorization is performed.
7a. The SMF selects a PCF
7b. The SMF may perform an SM Policy Association Establishment procedure to establish an SM Policy Association with the PCF and get the default PCC Rules for the PDU Session.
8. The SMF selects one or more UPFs
9. SMF may perform an SMF initiated SM Policy Association Modification procedure to provide information on the Policy Control Request Trigger condition(s) that have been met.
10 (a+b). The SMF initiates an N4 Session Establishment or Modification procedure with the selected UPF(s)
11. SMF sends Namf_Communication_N1N2MessageTransfer including N2 SM information to AMF.
   The N2 SM information carries information that the AMF shall forward to the (R)AN which includes inter alia:
   The CN Tunnel Info corresponds to the Core Network address(es) of the N3 tunnel corresponding to the PDU Session.
   One or multiple QoS profiles
   The PDU Session ID may be used by AN signalling with the UE to indicate to the UE the association between (R)AN resources and a PDU Session for the UE.
   A PDU Session is associated to an S-NSSAI of the HPLMN and, if applicable, to a S-NSSAI of the VPLMN, and a DNN.
12. The AMF sends the NAS message containing PDU Session ID and PDU Session Establishment Accept targeted to the UE and the N2 SM information received from the SMF within the N2 PDU Session Request to the (R)AN.
13. (R)AN to UE: The (R)AN may issue AN specific signalling exchange with the UE that is related with the information received from SMF.
14. (R)AN to AMF: N2 PDU Session Response
15. AMF to SMF: Nsmf_PDUSession_UpdateSMContext Request (SM Context ID, N2 SM information, Request Type). The AMF forwards the N2 SM information received from (R)AN to the SMF.
16a. The SMF initiates an N4 Session Modification procedure with the UPF.
16b. The UPF provides an N4 Session Modification Response to the SMF.
16c. If necessary, the SMF registers with the UDM using Nudm_UECM_Registration
17. The SMF may subscribe to the UE mobility event notification from the AMF (e.g. location reporting, UE moving into or out of Area Of Interest).
18. If during the procedure, any time after step 5, the PDU Session establishment is not successful, the SMF informs the AMF by invoking Nsmf_PDUSession_SMContextStatusNotify (Release). The SMF also releases any N4 session(s) created, any PDU Session address if allocated (e.g. IP address) and releases the association with PCF, if any. In this case, step 19 is skipped.
19. SMF to UE: In the case of PDU Session Type IPv6 or IPv4v6, the SMF generates an IPv6 Router Advertisement and sends it to the UE.
20. If the UE has indicated support of transferring Port Management Information Containers, then SMF informs PCF that a 5GS Bridge information is available.
21. If the PDU Session establishment failed after step 4, the SMF unsubscribes to the modifications of Session Management Subscription data.

In Xn based handover, as shown in FIG. 3, only N2 signaling could bypass NAS handler at AMF. Basically, the procedure shown in FIG. 3 works as follows at and after handover execution from Source gNB to Target gNB including forwarding of data:
1a. The source NG-RAN node during the handover execution phase may provide RAN usage data Report to the AMF.
1b. The Target NG-RAN sends an N2 Path Switch Request message to an AMF to inform that the UE has moved to a new target cell and provides a List of PDU Sessions To Be Switched. AN Tunnel Info for each PDU Session to be switched is included in the N2 SM Information.
2. The AMF sends N2 SM information by invoking the Nsmf_PDUSession_UpdateSMContext request service operation for each PDU Session in the lists of PDU Sessions received in the N2 Path Switch Request.
3. For PDU Sessions that are modified by the Target NG-RAN, the SMF sends an N4 Session Modification Request message to the UPF.
4. For the PDU Sessions that are switched, the UPF returns an N4 Session Modification Response message to the SMF after requested PDU Sessions are switched.
5. In order to assist the reordering function in the Target NG-RAN, the UPF sends one or more “end marker” packets for each N3 tunnel on the old path immediately after switching the path.
6. The SMF sends an Nsmf_PDUSession_UpdateSMContext response (N2 SM Information to the AMF for PDU Sessions which have been switched successfully. The CN Tunnel Info of UPF send to AMF is used to setup N3 tunnel.
7. Once the Nsmf_PDUSession_UpdateSMContext response is received from all the SMFs, the AMF aggregates received CN Tunnel Info and sends this aggregated information as a part of N2 SM Information along with the Failed PDU Sessions in N2 Path Switch Request Ack to the Target NG-RAN.
8. By sending a Release Resources message to the Source NG-RAN, the Target NG-RAN confirms success of the handover. It then triggers the release of resources with the Source NG-RAN.
9. The UE may initiate Mobility Registration Update procedure.

In N2 based handover, as shown in FIGS. 4 and 5, NAS is not involved. It may entirely bypass NAS handler. Basically, the handover preparation procedure shown in FIG. 4 works as follows
1. Source RAN (S-RAN) indicates to Source AMF (S-AMF) that a handover is required.
2. S-AMF selects the target AMF (T-AMF)
3. S-AMF may send to T-AMF: Namf_Communication_CreateUEContext Request (N2 Information (Target ID, Source to Target transparent container, SM N2 information list, PDU Session IDs), UE context information (SUPI, Service area restriction, Allowed NSSAI for each Access Type if available, Tracing Requirements, LTE M Indication, the list of PDU Session IDs along with the corresponding SMF information and the corresponding S-NSSAI(s), PCF ID(s), DNN, UE Radio Capability ID and UE Radio Capability Information).
4. For each PDU Session indicated by S-RAN, the T-AMF may invoke the Nsmf_PDUSession_UpdateSMContext Request to the associated SMF.
5. Based on the Target ID, SMF may check if N2 Handover for the indicated PDU Session can be accepted. The SMF may also select the UPF.
6a. [Conditional] SMF to UPF (PSA): N4 Session Modification Request.
6b. [Conditional] UPF (PSA) to SMF: N4 Session Modification Response.
6c. [Conditional] SMF to T-UPF (intermediate): N4 Session Establishment Request.
6d. T-UPF (intermediate) to SMF: N4 Session Establishment Response.
7. If N2 handover for the PDU Session is accepted, the SMF includes in the Nsmf_PDUSession_UpdateSMContext response the N2 SM Information containing the N3 UP address and the UL CN Tunnel ID of the UPF, the QoS parameters and TSCAI for the Target NG-RAN.
8. AMF supervises the Nsmf_PDUSession_UpdateSMContext Response messages from the involved SMFs.
9. T-AMF to T-RAN: Handover T-AMF determines T-RAN based on Target ID. T-AMF may allocate a 5G-GUTI valid for the UE in the AMF and target TAI.
10. T-RAN to T-AMF: Handover Request Acknowledge
11a. For each N2 SM response received from the T-RAN (N2 SM information included in Handover Request Acknowledge), AMF sends the received N2 SM response to the SMF indicated by the respective PDU Session ID.
11b. If the SMF selected a T-UPF in step 6a, the SMF updates the T-UPF by providing the T-RAN SM N3 forwarding information list by sending a N4 Session Modification Request to the T-UPF.
11c. The T-UPF allocates Tunnel Info and returns an N4 Session Modification Response message to the SMF.
11d. [Conditional] SMF to S-UPF: N4 Session Modification Request (T-RAN SM N3 forwarding Information list or T-UPF SM N3 forwarding Information list, indication to allocate DL forwarding tunnel(s) for indirect forwarding).
11e. The S-UPF may allocate Tunnel Info and returns an N4 Session establishment Response message to the SMF.
11f. The SMF sends an Nsmf_PDUSession_UpdateSMContext Response message per PDU Session to T-AMF.
12. T-AMF sends the Namf_Communication_CreateUEContext Response to the S-AMF.

Basically, the handover execution phase shown in FIG. 5 works as follows:
1. S-AMF sends to S-RAN the Handover Command.
2. S-RAN sends to UE the Handover Command.
2a.-2c. The S-RAN may send the Uplink RAN Status Transfer message to the S-AMF.
3. Uplink packets are sent from T-RAN to T-UPF and UPF (PSA). Downlink packets are sent from UPF (PSA) to S-RAN via S-UPF. The S-RAN should start forwarding of downlink data from the S-RAN towards the T-RAN for QoS Flows or DRBs subject to data forwarding. This may be either direct (step 3a) or indirect forwarding (step 3b).
4. After the UE has successfully synchronized to the target cell, it sends a Handover Confirm message to the T-RAN.
5. T-RAN to T-AMF: Handover Notify.
   Handover is by this message considered as successful in T-RAN.
6a. The T-AMF notifies to the S-AMF about the N2 handover notify received from the T-RAN by invoking the Namf_Communication_N2InfoNotify.
6b. The S-AMF acknowledges by sending the Namf_Communication_N2InfoNotify ACK to the T-AMF.
6c. If the PDU Session(s) is not accepted by the T-AMF (e.g. S-NSSAI associated with the PDU Session is not available in the T-AMF), S-AMF triggers PDU Session Release procedure.
7. Handover Complete indication is sent per each PDU Session to the corresponding SMF to indicate the success of the N2 Handover.
8a. If new T-UPF is inserted or an existing intermediate S-UPF is re-allocated, the SMF shall send N4 Session Modification Request indicating DL AN Tunnel Info of T-RAN to the T-UPF.
8b. The T-UPF acknowledges by sending N4 Session Modification Response message to SMF.
9a. If UPF is not re-allocated, the SMF shall send N4 Session Modification Request indicating DL AN Tunnel Info of T-RAN to the S-UPF.
9b. The S-UPF acknowledges by sending N4 Session Modification Response message to SMF.
10a. For non-roaming or local breakout roaming scenario, the SMF sends N4 Session Modification Request message to PDU Session Anchor UPF.
10b. The UPF (PSA) sends N4 Session Modification Response message to SMF.
11. SMF confirms reception of Handover Complete.
12. The UE initiates Mobility Registration Update procedure.
13a. If there is a source intermediate UPF, the SMF initiates resource release.
13b. The S-UPF acknowledges with an N4 Session Release Response message to confirm the release of resources.
14a. The AMF may send UE Context Release Command.
14b. The source NG-RAN releases its resources related to the UE and responds with a UE Context Release Complete ( ) message.
15a. If indirect forwarding applies and UPF is re-allocated, the SMF may send N4 Session Modification Request to T-UPF to release the indirect data forwarding resource.
15b. The T-UPF acknowledges with an N4 Session Modification Response message to confirm the release of indirect data forwarding resources.

In a Service Request procedure, as shown in FIG. 6, the AMF/NAS handler is aware of PDU sessions and SMFs serving them. Basically, the service request procedure shown in FIG. 6 works as follows:
1. UE sends to (R)AN a service request (AN message (AN parameters, Service Request (List Of PDU Sessions To Be Activated, List Of Allowed PDU Sessions, security parameters, PDU Session status, 5G-S-TMSI, [NAS message container], Exempt Indication))).
2. (R)AN forwards the service request to AMF by a N2 Message
3. A security context is established if needed.
4. AMF to SMF: The Nsmf_PDUSession_UpdateSMContext Request is invoked.
5a. If the AMF notified the SMF that the access type of the PDU session can be changed in step 4, and if PCC is deployed, the SMF perform an SMF initiated SM Policy Association Modification procedure.
5b. SMF may select a UPF.
6a. SMF may send N4 Session Modification Request message to UPF (PSA) and requests CN Tunnel Info providing the target Network Instance.
6b. The UPF (PSA) sends an N4 Session Establishment Response message to the SMF.
6c. If the SMF selects a new UPF to act as intermediate UPF for the PDU Session, or if the SMF selects to insert an intermediate UPF for a PDU Session which did not have an intermediate UPF, an N4 Session Establishment Request message is sent to the new UPF
6d. The new intermediate UPF sends an N4 Session Establishment Response message to the SMF.
7a. If the SMF selects a new UPF to act as intermediate UPF for the PDU Session, the SMF sends N4 Session Modification Request message to PDU Session Anchor UPF, providing DL Tunnel Info from new intermediate UPF.
7b. The UPF (PSA) sends N4 Session Modification Response message to SMF.
8b. old UPF (intermediate) to SMF: N4 Session Modification Response The old (intermediate) UPF sends N4 Session Modification Response message to SMF.
9. The SMF initiates N4 Session Modification procedure to indicate the new I-UPF to send the buffered downlink packet(s) received from the UPF (PSA).
10. The old (intermediate) UPF forwards its buffered data to the UPF (PSA) acting as N3 Terminating Point.
11. The SMF generates only N2 SM information and sends Nsmf_PDUSession_UpdateSMContext Response to the AMF to establish the User Plane(s).
12. AMF to (R)AN: N2 Request (N2 SM information received from SMF, security context, Mobility Restriction List, UE-AMBR, MM NAS Service Accept, list of recommended cells/TAs/NG-RAN node identifiers, UE Radio Capability, Core Network Assistance Information, Tracing Requirements, UE Radio Capability ID).
13. The NG-RAN performs RRC Connection Reconfiguration with the UE depending on the QoS Information for all the QoS Flows of the PDU Sessions whose UP connections are activated and Data Radio Bearers.
14. (R)AN to AMF: N2 Request Ack (List of PDU Sessions To Be Established with N2 SM information (AN Tunnel Info, List of accepted QoS Flows for the PDU Sessions whose UP connections are activated, List of rejected QoS Flows for the PDU Sessions whose UP connections are activated), List of PDU Sessions that failed to be established with the failure cause given in the N2 SM information element).
15. The AMF determines Access Type and RAT Type. If the AMF received N2 SM information (one or multiple) in step 14, then the AMF shall forward the N2 SM information to the relevant SMF per PDU Session ID.
16. [Optional] SMF to PCF: If dynamic PCC is deployed, SMF may initiate notification about new location information to the PCF (if subscribed) by performing an SMF initiated SM Policy Modification procedure as defined in clause 4.16.5.1. The PCF may provide updated policies.
17a. If the SMF selected a new UPF to act as intermediate UPF for the PDU Session in step 5b, the SMF initiates a N4 Session Modification procedure to the new I-UPF and provides AN Tunnel Info. The Downlink Data from the new I-UPF can now be forwarded to NG-RAN and UE.
17b. UPF to SMF: N4 Session Modification Response.
18a. If a User Plane is to be setup or modified and after the modification there is no I-UPF, the SMF initiates a N4 Session Modification procedure to UPF (PSA) and provides AN Tunnel Info. The Downlink Data from the UPF (PSA) can now be forwarded to NG-RAN and UE.
18b. UPF to SMF: N4 Session Modification Response.
19. SMF to AMF: Nsmf_PDUSession_UpdateSMContext Response.
20a. If forwarding tunnel has been established to the new I-UPF, SMF sends N4 Session modification request to new (intermediate) UPF acting as N3 terminating point to release the forwarding tunnel.
20b. New (intermediate) UPF acting as N3 terminating point sends N4 Session Modification response to SMF.
21a. If forwarding tunnel has been established to the UPF (PSA), SMF sends N4 Session modification request to UPF (PSA) acting as N3 Terminating Point to release the forwarding tunnel.
21b. UPF (PSA) acting as N3 Terminating Point sends N4 Session Modification Response to SMF.
22a. If the SMF decided to continue using the old UPF in step 5b, the SMF sends an N4 Session Modification Request, providing AN Tunnel Info.
22b. The old UPF acknowledges with an N4 Session Modification Response or N4 Session Release Response message to confirm the modification or release of resources.

Details of the procedures shown in FIGS. 2 to 6 are explained in 3GPP TS 23.502.

There is a discussion to introduce the benefits of a service-based architecture also within the RAN (see PCT EP/2020/087184 and PCT EP/2021/053293).

### SUMMARY

It is an object of the present invention to improve the prior art.

According to a first aspect of the invention, there is provided an apparatus comprising:
one or more processors, and
   memory storing instructions that, when executed by the one or more processors, cause the apparatus to perform:
receiving, from a first network function of a first domain, a request for a first service related to one of one or more terminals or to one or more protocol data unit sessions of the one or more terminals,
identifying an address of one of one or more second network functions of a second domain based on the requested first service, the one or more terminals and the one ore more protocol data unit sessions, respectively, and a first mapping relationship;
forwarding the request or redirecting the request towards the one second network function, wherein
the first mapping relationship indicates, for each of the one or more terminals and for each of the one or more protocol data unit sessions of the one or more terminals, respectively, a respective address of the one second network function capable to serve the one or more terminals or the one or more protocol data unit sessions of the one or more terminals.

According to a second aspect of the invention, there is provided an apparatus comprising:
one or more processors, and
   memory storing instructions that, when executed by the one or more processors, cause the apparatus to perform:
monitoring whether a terminal performs a handover from a source access node to a target access node;
storing a pair of information in the source access node if the terminal performs the handover, wherein the pair of information comprises an identity of the terminal and an identity of the target access node;
supervising whether the source access node receives a request for the terminal;
retrieving the identity of the target access node based on the identity of the terminal if the source access node receives the request for the terminal;
forwarding or redirecting the request towards the target access node using the retrieved identity of the target access node.

According to a third aspect of the invention, there is provided an apparatus comprising: one or more processors, and
memory storing instructions that, when executed by the one or more processors, cause the apparatus to perform:
monitoring whether a redirect response is received in response to a first service based request sent to a terminal, wherein the first service based request comprises a first identity of the terminal, and the redirect response comprises a second identity of the terminal and a redirection address;
creating a second service based request based on the first service based request if the redirect response is received, wherein the second service based request is directed to the redirection address and comprises the second identity of the terminal;
resending the second service based request.

According to a fourth aspect of the invention, there is provided a method comprising:
receiving, from a first network function of a first domain, a request for a first service related to one of one or more terminals or to one or more protocol data unit sessions of the one or more terminals,
identifying an address of one of one or more second network functions of a second domain based on the requested first service, the one or more terminals and the one ore more protocol data unit sessions, respectively, and a first mapping relationship;
forwarding the request or redirecting the request towards the one second network function, wherein
the first mapping relationship indicates, for each of the one or more terminals and for each of the one or more protocol data unit sessions of the one or more terminals, respectively, a respective address of the one second network function capable to serve the one or more terminals or the one or more protocol data unit sessions of the one or more terminals.

According to a fifth aspect of the invention, there is provided a method comprising:
monitoring whether a terminal performs a handover from a source access node to a target access node;
storing a pair of information in the source access node if the terminal performs the handover, wherein the pair of information comprises an identity of the terminal and an identity of the target access node;
supervising whether the source access node receives a request for the terminal;
retrieving the identity of the target access node based on the identity of the terminal if the source access node receives the request for the terminal;
forwarding or redirecting the request towards the target access node using the retrieved identity of the target access node.

According to a sixth aspect of the invention, there is provided a method comprising:
monitoring whether a redirect response is received in response to a first service based request sent to a terminal, wherein the first service based request comprises a first identity of the terminal, and the redirect response comprises a second identity of the terminal and a redirection address;
creating a second service based request based on the first service based request if the redirect response is received, wherein the second service based request is directed to the redirection address and comprises the second identity of the terminal;
resending the second service based request.

Each of the methods of the fourth to sixth aspects may be a method of handling mobility.

According to a seventh aspect of the invention, there is provided a computer program product comprising a set of instructions which, when executed on an apparatus, is configured to cause the apparatus to carry out the method according to any of the fourth to sixth aspects. The computer program product may be embodied as a computer-readable medium or directly loadable into a computer.

According to some embodiments of the invention, at least one of the following advantages may be achieved:
SBA may be employed in both CN and AN;
security concerns are overcome.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 shows interfaces of a 5GS;

FIG. 2 replicates 3GPP TS 23.502 FIG. 4.3.2.2.1-1: UE-requested PDU Session Establishment for non-roaming and roaming with local breakout;

FIG. 3 replicates 3GPP TS 23.502 FIG. 4.9.1.2.2-1: Xn based inter NG-RAN handover without UPF re-allocation;

FIG. 4 replicates 3GPP TS 23.502 FIG. 4.9.1.3.2-1: Inter NG-RAN node N2 based handover, Preparation phase;

FIG. 5 replicates 3GPP TS 23.502 FIG. 4.9.1.3.3-1: inter NG-RAN node N2 based handover, execution phase;

FIG. 6 replicates 3GPP TS 23.502 FIG. 4.2.3.2-1: UE Triggered Service Request procedure

FIG. 7 shows a message flow according to some example embodiments of the invention;

FIG. 8 shows a message flow according to some example embodiments of the invention;

FIG. 9 shows a message flow according to some example embodiments of the invention;

FIG. 10 shows a message flow according to some example embodiments of the invention;

FIG. 11 shows a message flow according to some example embodiments of the invention;

FIG. 12 shows a message flow according to some example embodiments of the invention;

FIG. 13 shows a message flow according to some example embodiments of the invention;

FIG. 14 shows a message flow according to some example embodiments of the invention;

FIG. 15 shows a message flow according to some example embodiments of the invention;

FIG. 16 shows an apparatus according to an example embodiment of the invention;

FIG. 17 shows a method according to an example embodiment of the invention;

FIG. 18 shows an apparatus according to an example embodiment of the invention;

FIG. 19 shows a method according to an example embodiment of the invention;

FIG. 20 shows an apparatus according to an example embodiment of the invention;

FIG. 21 shows a method according to an example embodiment of the invention; and

FIG. 22 shows an apparatus according to an example embodiment of the invention.

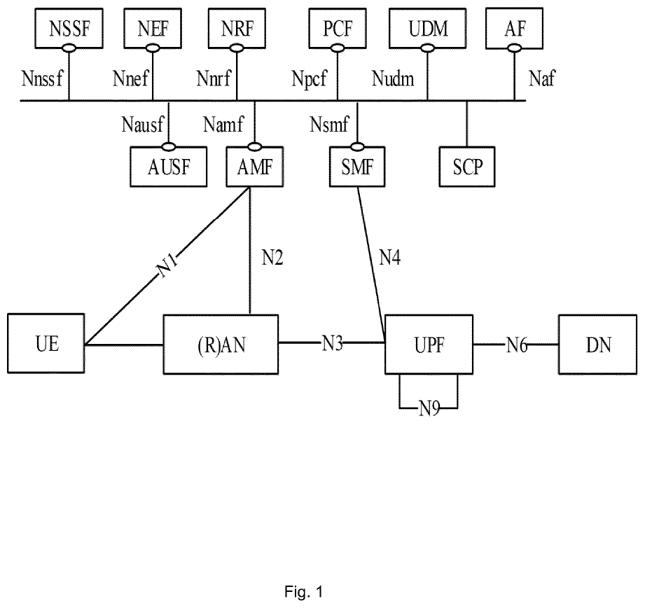

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

Hereinafter, the terms “serving a UE” and “serving a UE's context” and the terms “serving a PDU session” and “serving a PDU's session context” are used synonymously, unless otherwise indicated or made clear from the context.

If RAN is service based, currently there isn't any solution for requests sent towards a RAN node (gNB) after it has handed over a UE context or lost the N2 association because the UE become idle. Furthermore, there isn't any solution allowing RAN nodes to directly address services that might be offered by 5GC nodes. In particular, RAN nodes are able to discover 5GC nodes handling a UE context or PDU session, and core nodes do not understand the provided RAN specific PDU identities. At the same time, a security protection between RAN and core network should be maintained.

According to some example embodiments of the invention, solutions are provided for one or both of a SB request towards an AN node and a SB request towards a CN node.

Namely, it is provided a mobility proxy, hereinafter sometimes also denoted as “proxy”.

The mobility proxy may act as follows:

### 1) SB Request Towards AN Node:

Mobility proxy has access to information about the identity (e.g. Address information, a node ID or a set ID) of access network node (e.g. gNB) serving a UE context, as identified by some UE identity and handles HTTP request to be sent to the access network node serving a UE context. It determines the address of the access network node and either forwards or redirects the HTTP request towards that access network node. “Redirecting the HTTP request towards that access node” means that the mobility proxy sends a redirect response in response to the HTTP request, wherein the redirect response comprises an address of that access node.

### 2) SB Request Towards CN Node:

Mobility proxy has access to information about the identity (e.g. Address information, a node ID or a set ID) of core network node (e.g. SMF) serving a UE context or a PDU session, as identified by some UE identity or by a PDU session identity and handles HTTP request to be sent to the core network node serving a UE context or a PDU session. It determines the address of the core network (CN) node and either forwards or redirects the HTTP request towards that core network node.

Hereinafter, both options for the mobility proxy are explained at greater detail:

### 1) SB Request Towards AN Node:

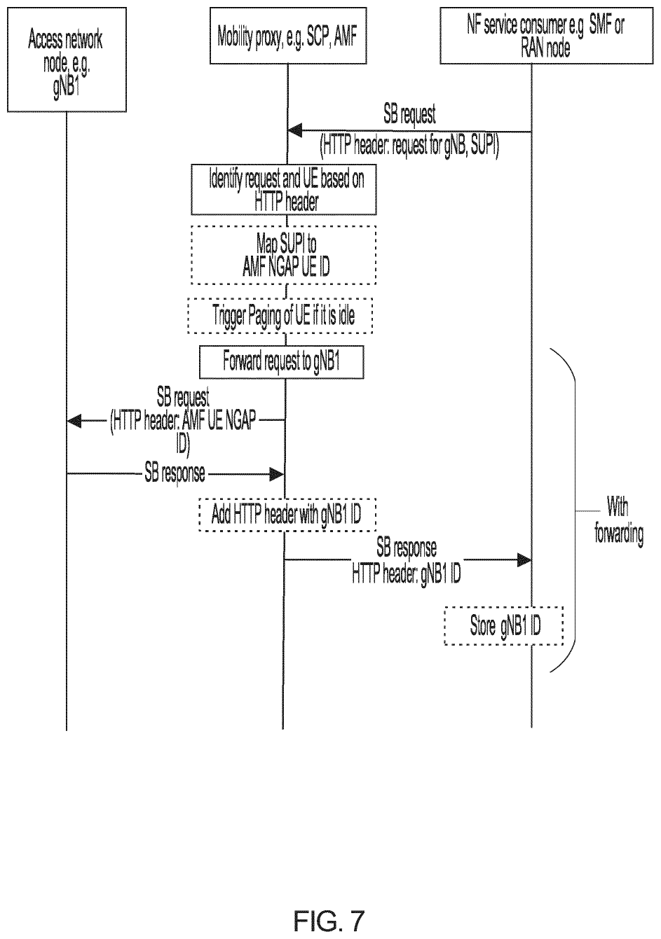

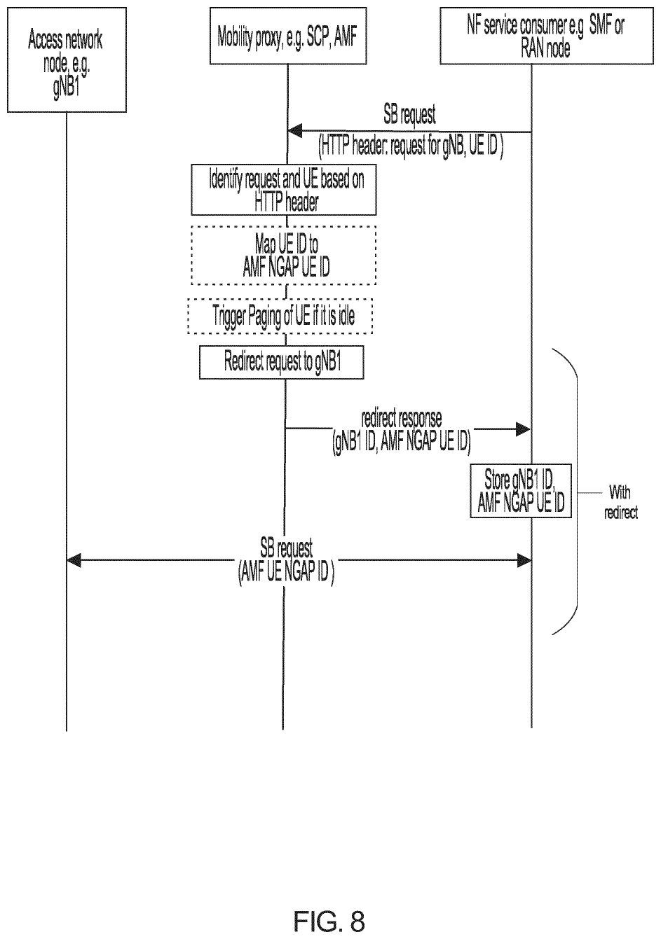

Mobility proxy has access to information about the identity (e.g. Address information, a node ID or a set ID if plural nodes are summarized as one set of nodes) of access network node (e.g. gNB) serving a UE context, as identified by some UE identity (e.g. SUPI, AMF UE NGAP ID, GUTI) and handles a HTTP request to be sent to the access network node serving a UE context. It determines the address of the access network node and either forwards (FIG. 7) or redirects (FIG. 8) the HTTP request towards that access network node.

As shown in FIG. 7, a NF service consumer issues a service-based request towards the mobility proxy. The request is directed to the gNB serving a UE identified by an identifier such as a SUPI. These IEs are included in the header of the SB request. The NF service consumer may be a NF of the CN (such as a SMF) or a NF of the (R)AN (such as a RAN node (gNB)).

The mobility proxy identifies the request and the UE based on the HTTP header. If the UE identifier (e.g. SUPI) in the request is different from the UE identifier (e.g. AMF NGAP UE ID) used by the AN, the proxy maps the received UE identifier on the other UE identifier based on a stored mapping relationship. If the mobility proxy knows that the UE is idle, the mobility proxy may trigger paging the UE.

The mobility proxy knows that gNB1 serves the UE. Therefore, it forwards the received SB request to gNB1, wherein the HTTP header in the forwarded SB request comprises the UE identity used by the AN (e.g. AMF NGAP UE ID). The UE identity of the received request may be additionally included in the forwarded request or it may be omitted.

gNB1 receives the SB request, provides the requested service for the UE, and replies to the mobility proxy by SB response. Mobility proxy may add a HTTP header with gNB1 ID and forwards the SB response to the NF service consumer. The latter may optionally store gNB1 ID related to the UE for further usage.

FIG. 8 corresponds to FIG. 7. However, instead of forwarding, redirecting is applied. That is, after the potential triggering of paging, mobility proxy provides a redirect response to the NF service consumer. The redirect response comprises the ID of gNB1 serving the UE and the identifier used in the AN to identify the UE (e.g. AMF NGAP UE ID). When NF service consumer receives the redirect response, it may optionally store the ID of gNB1 related to the UE for further usage. In addition, it will resent the SB request to gNB1, wherein the SB request comprises the UE identifier used in the AN (e.g. AMF NGAP UE ID) in the header.

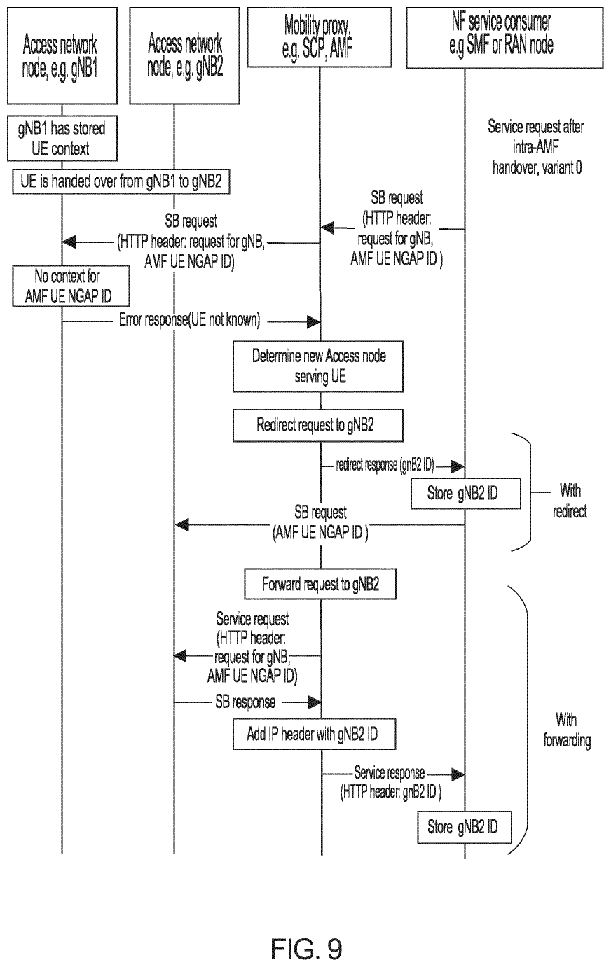

Each of the following FIGS. 9 to 12 and 15 shows both options, where the mobility proxy forwards the SB request, and where the mobility proxy redirects the SB request. Of course, the mobility proxy performs either forwarding or redirecting.

Some (potentially optional) features of the mobility proxy are explained hereinafter:
The mobility proxy may be integrated in an AMF, an SCP, or a database holding information on the identity of an access network node serving a UE context.
The mobility proxy may interact with an AMF or a database holding information on access network node(s) serving a UE context to retrieve information on the identity of the access network node(s) (e.g. gNB) serving a UE context.
When receiving a service request for a specific type of access network node and specific UE, the mobility proxy determines the access network node serving the UE. The mobility proxy then either forwards the service request toward that access node, or it performs HTTP redirect to instruct the NF service consumer to forward the request to the access node (the access network ID and UE ID may be provided in the body of the related HTTP 3xx response).
In a variant, the mobility proxy is deployed at the border between core network and radio network and handles all HTTP requests (e.g. service requests, notifications) sent from core to access network and from access network towards the core. It performs security related procedures to shield the access and the core network from each other:
   It interworks UE identities as used in the core network, e.g. SUPI, with UE identities in the radio network, e.g. AMF NGAP UE ID.
   It verifies the identity of the sender and checks whether the sender is authorized to communicate over the border between RAN and core network, to invoke the requested service, to communicate with the requested type of network function, and/or to communicate with respect to the indicated UE.
In a variant, if access network nodes are organized in sets that have access to the same UE context, the mobility proxy selects instances within the set, and may re-select instances based on load and availability.
In a variant, to support different UE identities being used in core network and radio network, the mobility proxy has access to information on the core UE identity (e.g. SUPI) and corresponding radio UE identity (e.g. AMF NGAP UE ID). If the mobility proxy receives a request with the core UE identity:
   If the mobility proxy forwards the HTTP request, it adds an HTTP header with the radio UE identity in the forwarded HTTP request and optionally in the related HTTP response.
   If the mobility proxy redirects the HTTP request, it adds an HTTP header with the radio UE identity in the HTTP redirect response.
In a variant, to support a change of the UE identity, the mobility proxy has access to information on the old UE identity and corresponding new UE identity. If the mobility proxy receives a request with the old UE identity and determines that a new UE identity was assigned:
   If the mobility proxy forwards the HTTP request, it adds an HTTP header with the new UE identity in the forwarded HTTP request and optionally in the related HTTP response.
   If the mobility proxy redirects the HTTP request, it adds an HTTP header with the new UE identity in the HTTP redirect response.
In a variant, if the mobility proxy forwards the HTTP request, it adds an HTTP header with an identity of the access network node in the related HTTP response.
In a variant, the mobility proxy determines whether the UE is idle and, if this is the case, triggers a paging of the UE, e.g. by requesting an AMF to page the UE, or by paging the UE itself (e.g. if the mobility proxy is integrated in the AMF).
In a variant, to facilitate handling by the mobility proxy, HTTP header(s) indicating the type of the access network node (e.g. gNB), or the type of the network access (e.g. 3GPP or non-3GPP access), and/or service that the request is targeting, and/or the UE identity, are added to the request by NF service consumers. This allows handling the request by the mobility proxy without inspecting the request body and supporting the service addressed by the request.

If an access network node (e.g. gNB) receives a service request relating to a UE context, as identified by some UE identity (e.g. AMF UE NGAP ID, GUTI), but does not hold this UE context, it may perform one of the following (This may occur e.g. after a handover, or after the UE context was released in the access network node because the UE entered the idle state):
It rejects the request with an error indicating that the UE identity is unknown. This variant is preferable if the Mobility proxy handles all service requests and applies request forwarding.
   The Mobility proxy then determines the new access node and/or initiates a paging of the UE. The mobility proxy may interact with a database of the AMF for that purpose.
   The mobility proxy forwards or redirects the service request to the new access network node.

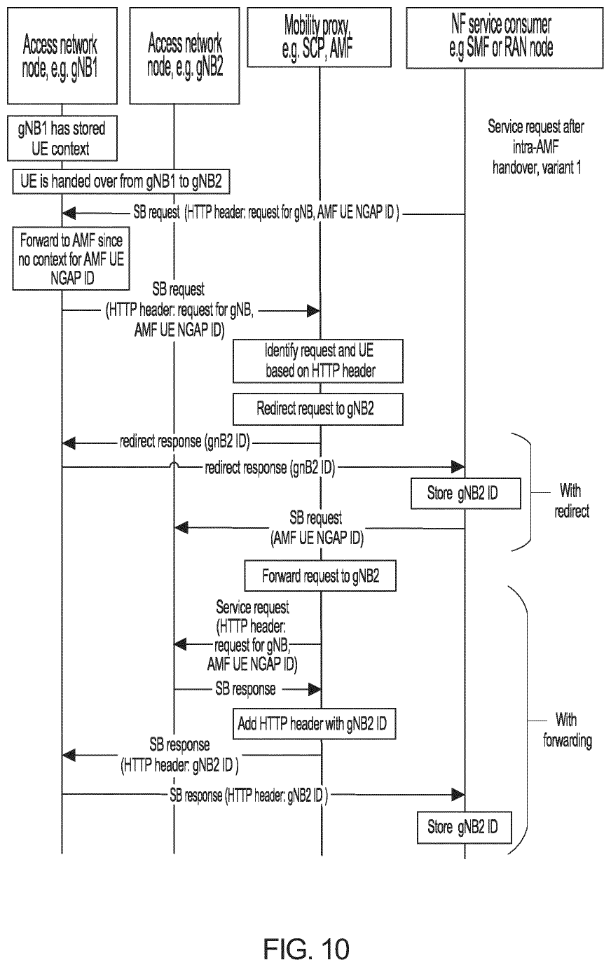

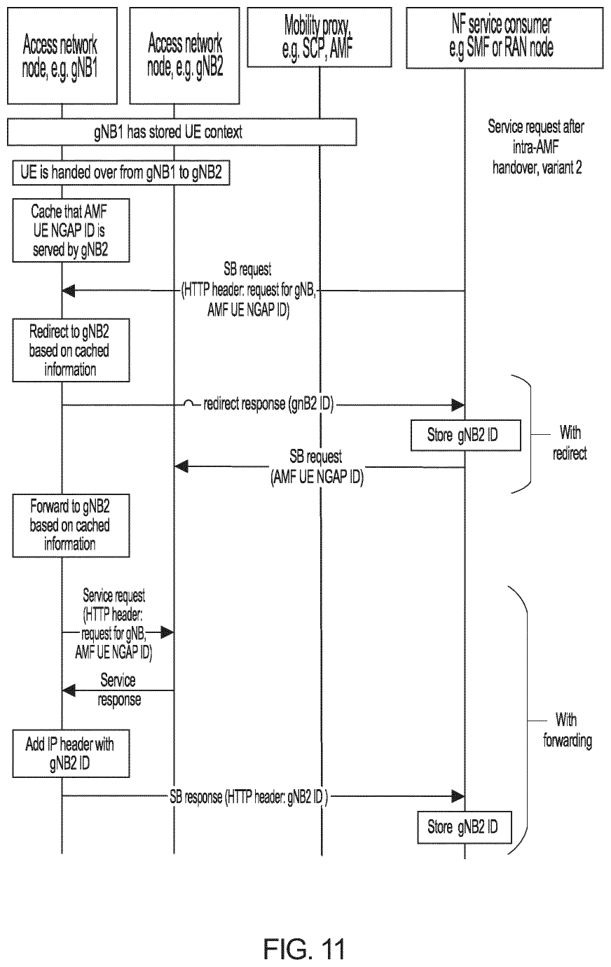

This variant is shown in FIG. 9 (the option of initiating paging is not shown). FIG. 9 corresponds substantially to FIGS. 7 and 8, where the mobility proxy additionally determines the new access node serving the UE.
In a variant, the access network node forwards request towards to mobility proxy. This variant is shown in FIG. 10. In contrast to the message flows of FIGS. 7 to 9, in this message flow, the NF service consumer directs its request directly to the access node (gNB1), not via the mobility proxy. Therefore, gNB1 does not provide an error response to the mobility proxy but forwards the received SB request to the mobility proxy. Otherwise, FIG. 10 corresponds to FIG. 9.
In a variant, after a handover, the old access network node stores the identity (e.g. Address information, a node ID, or a set ID) of the new access network node holding the UE context fora transition period. If the access network node receives a service request relating to the cached UE context, it forwards or redirects that service requests towards the stored new access network node.
   If the access network node forwards the HTTP request, it adds an HTTP header with the identity of the new access network node in the related HTTP response.
   If the access network node redirects the HTTP request, it adds an HTTP header with the identity of the new access network node in the HTTP redirect response.
This variant is shown in FIG. 11. After the transition period, the old access node may delete the identity of the new access node.

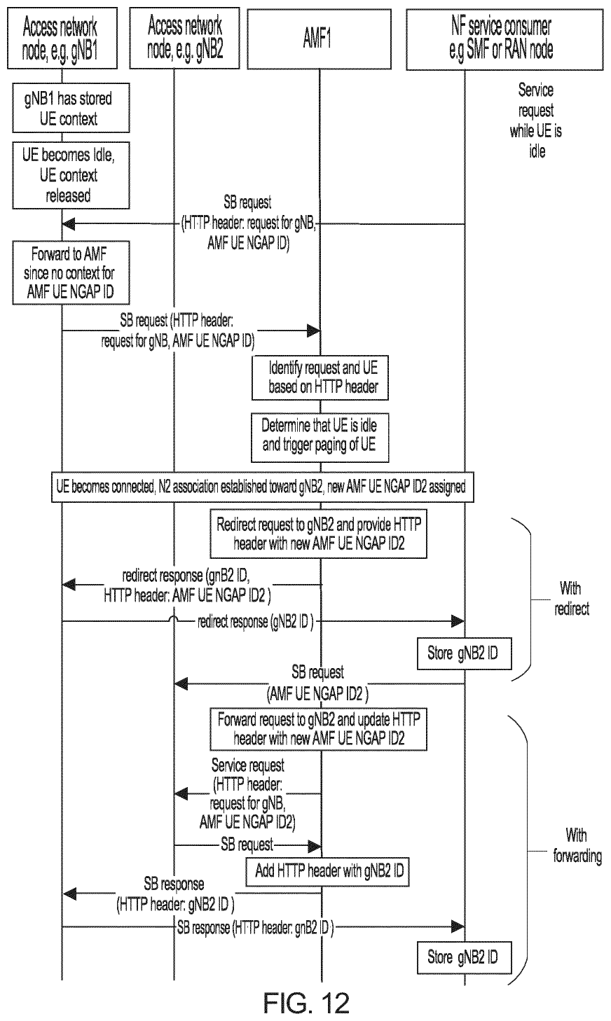

FIG. 12 corresponds to FIG. 10, but for a case that the UE is gone to idle instead of being handovered. Accordingly, when mobility proxy receives the SB request from gNB1, it triggers paging of the UE. In this case, the UE is then connected to gNB2, but this is not limited. E.g., UE may be connected to gNB1 instead.

If an AMF as a mobility proxy receives a service request for an unknown UE identity (e.g. AMF UE NGAP ID), it may reject the request with an error indication that the UE context was lost. (This can occur after an inter-AMF handover). The NF service consumer may then discover the new access network node and resend the service request.

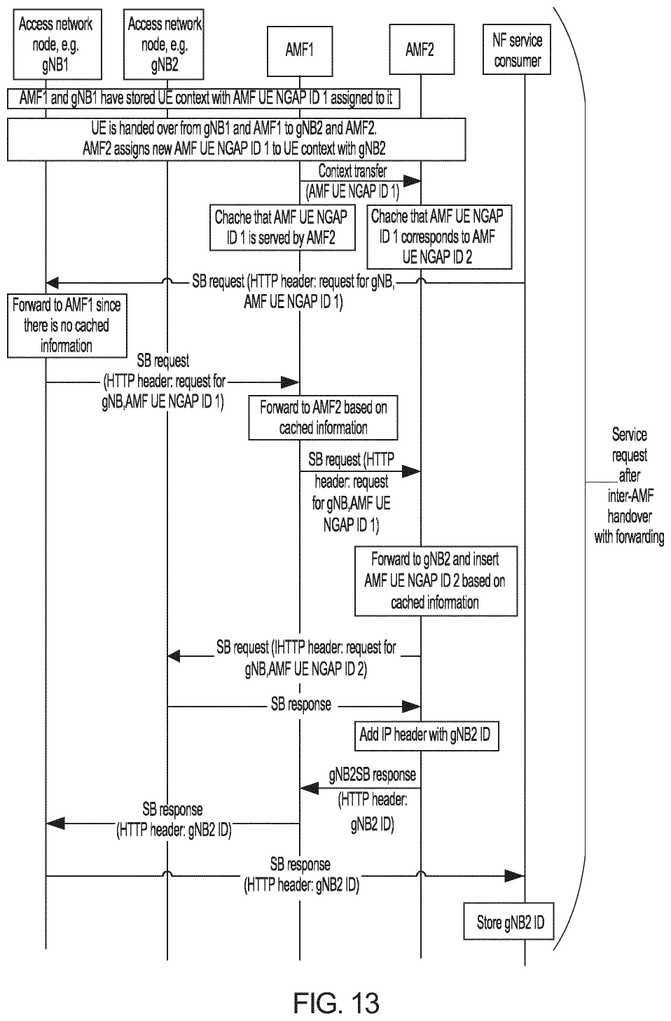

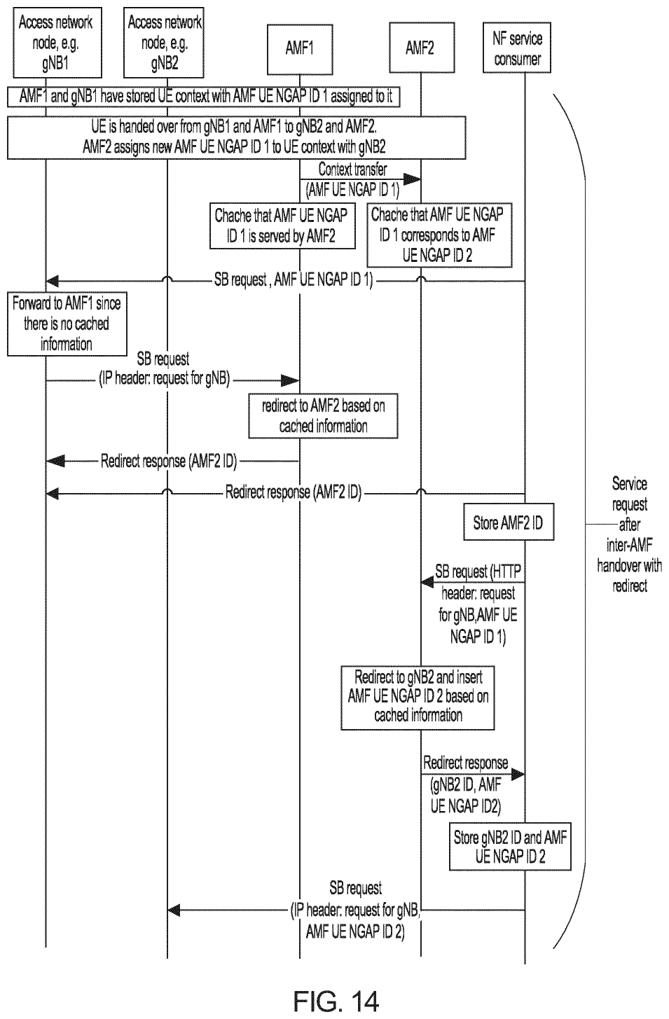

In one embodiment, during an inter-AMF handover the old AMF transfers the UE identity (e.g. AMF UE NGAP ID) to the new AMF and also caches the new AMF ID for the UE identity. The new AMF then either uses the same UE identity toward the new access network node (e.g. gNB) that handles the UE context or assigns a new UE identity and caches that the old UE identity was replaced by the new UE identity. If the old AMF then receives a request targeting the old UE identity, it either forwards (FIG. 13) or redirects (FIG. 14) the request to the new AMF, and the new AMF then forwards or redirects the request to the new access network node.

That is, for the option of forwarding shown in FIG. 13, AMF1 and gNB1 first store UE context where the UE is identified by AMF UE NGAP ID1. Then the UE is handed over the gNB2 and AMF2. AMF2 may assign a new ID AMF UE NGAP ID2 to the UE context, which is also notified to gNB2. Then, the UE context is transferred from AMF1 to AMF2 using the old UE ID AMF UE NGAP ID1. AMF1 caches that the UE (identified by the old UE ID AMF UE NGAP ID1) is now served by AMF2. AMF2 caches that the old UE ID AMF UE NGAP ID1 corresponds to the new UE ID AMF UE NGAP ID2.

NF service consumer is not aware of the handover and sends a service request related to the UE to gNB1 using the old UE ID AMF UE NGAP ID1. gNB1 does not know the old UE ID and forwards the request to its AMF1. Based on the cached information, AMF1 forwards the request to AMF2. AMF2, based on its cached information, replaces the old UE ID by the new UE ID AMF UE NGAP ID2 and forwards the SB request to gNB2. gNB2 provides the service and sends its response to AMF2. AMF2 may add an IP header with the ID of gNB2 and/or the new UE ID AMF UE NGAP ID 2, and sends the SB response to AMF1, which sends the response to gNB1, and sends the response back to the NF service consumer. The NF service consumer may store the ID of gNB2 related to the UE, and may also replace the old stored UE ID by the new UE ID

If the option of redirecting is adopted, as shown in FIG. 14, AMF1, when AMF1 receives the SB request from gNB1, it sends a redirect response comprising the ID of AMF2 to gNB1, based on its cached information. The UE ID AMF UE NGAP ID1 is maintained. gNB1 sends the redirect response further to the NF service consumer. The NF service consumer may store the ID of AMF2 related to the UE. Then, it sends the SB request to AMF2, but with the old UE ID AMF UE NGAP ID1. Based on its cached information, AMF2 replaces the old UE ID AMF UE NGAP ID1 by the new UE ID AMF UE NGAP ID2, and sends a corresponding redirect response back to the NF service consumer indicating gNB2 as the new address. The NF service consumer may store the ID of gNB2 related to the UE, and may also replace the old stored UE ID by the new UE ID. Then the NF service consumer sends the SB request to gNB2 using the new UE ID AMF UE NGAP ID2.

In some example embodiments, forwarding and redirecting may be mixed. For example, in the scenarios of FIGS. 13 and 14, AMF1 may apply redirection and AMF2 may apply forwarding, or AMF1 may apply forwarding and AMF2 may apply redirection.

As shown in FIGS. 7 to 14, the NF service consumer may optionally cache information about access network nodes and UE identities received in HTTP responses or redirect responses and use this information in subsequent requests.

In FIGS. 7 to 14, the service consumer identifies the UE by some UE identifier, such as SUPI. In some example embodiments, instead of or in addition to the UE identifier, an identifier of a PDU session of the UE may be used.

### 2) SB Request Towards CN Node:

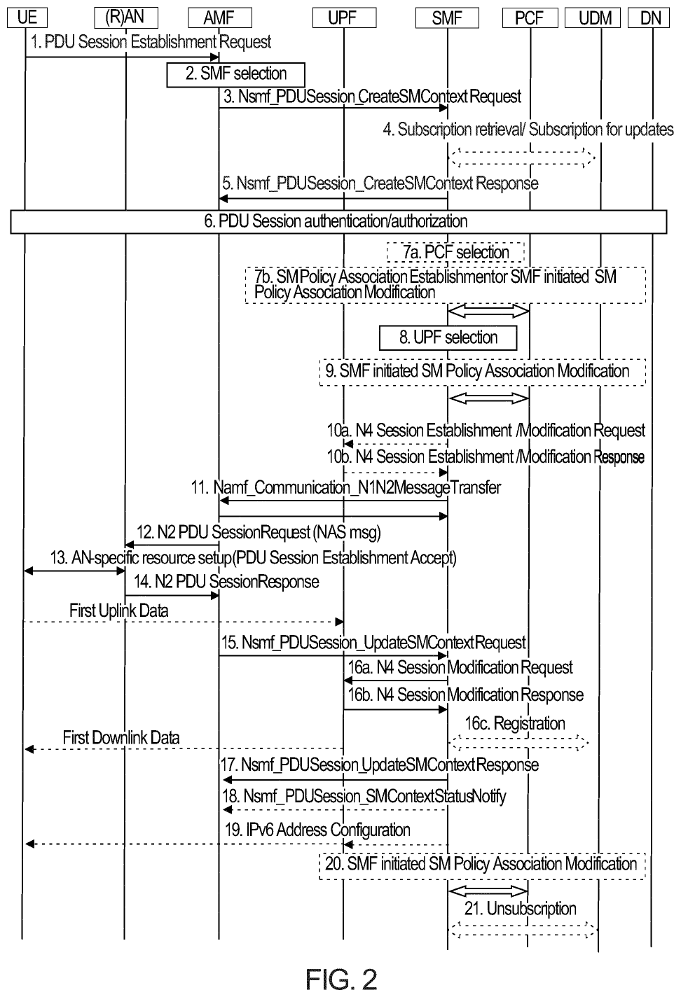

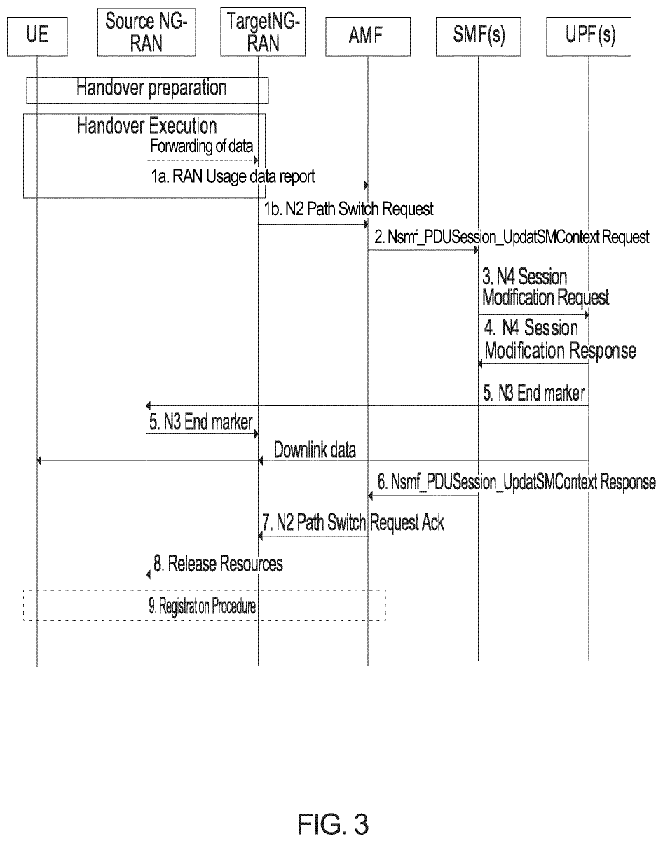

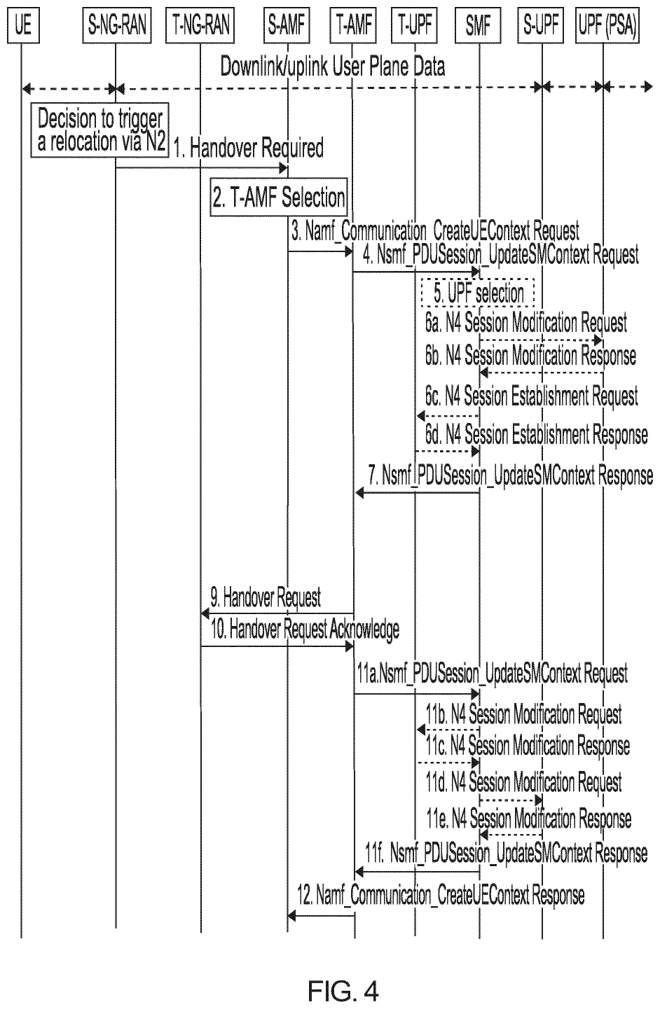

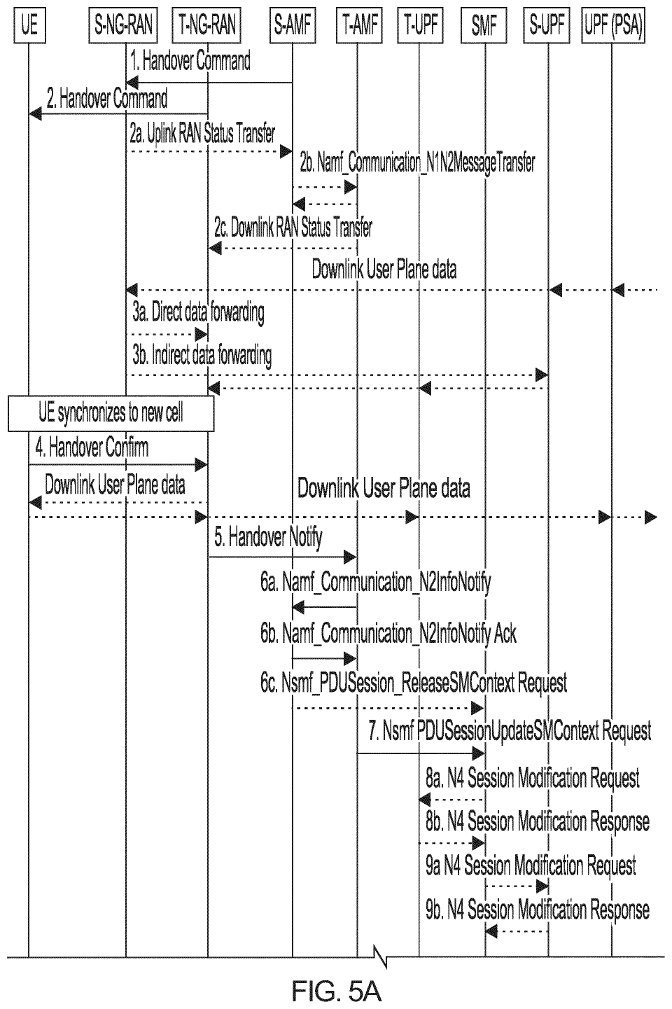

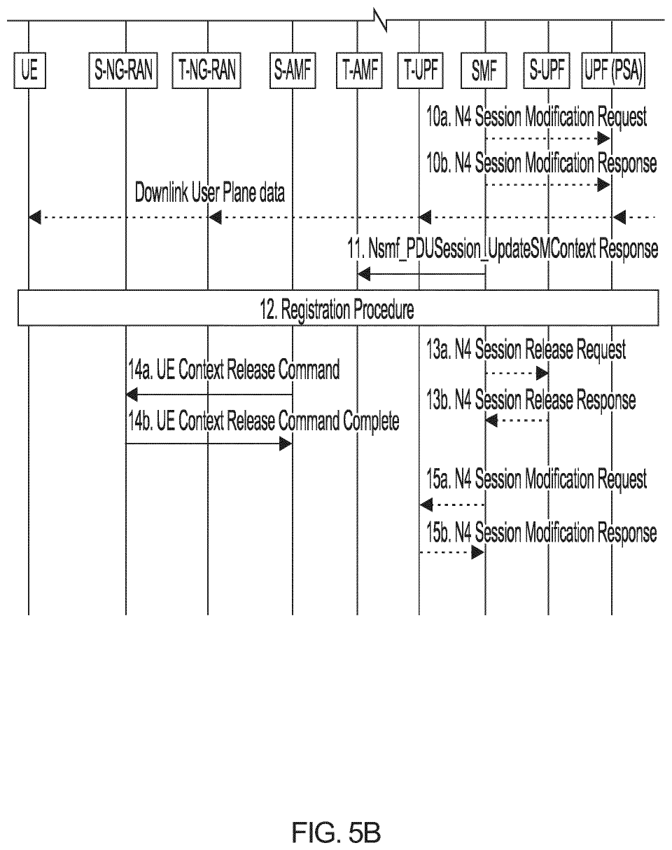

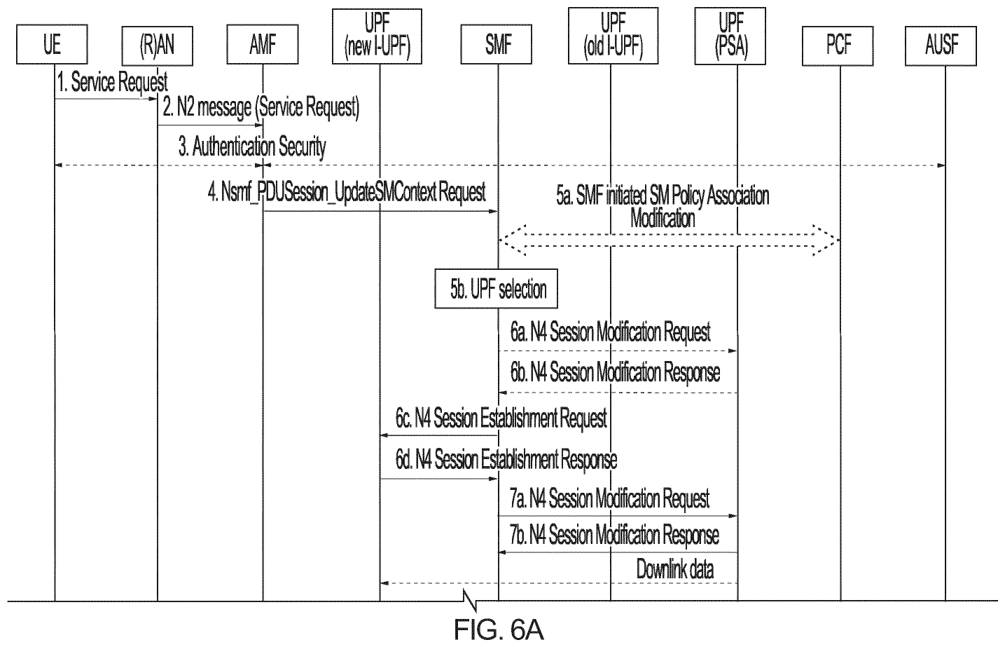

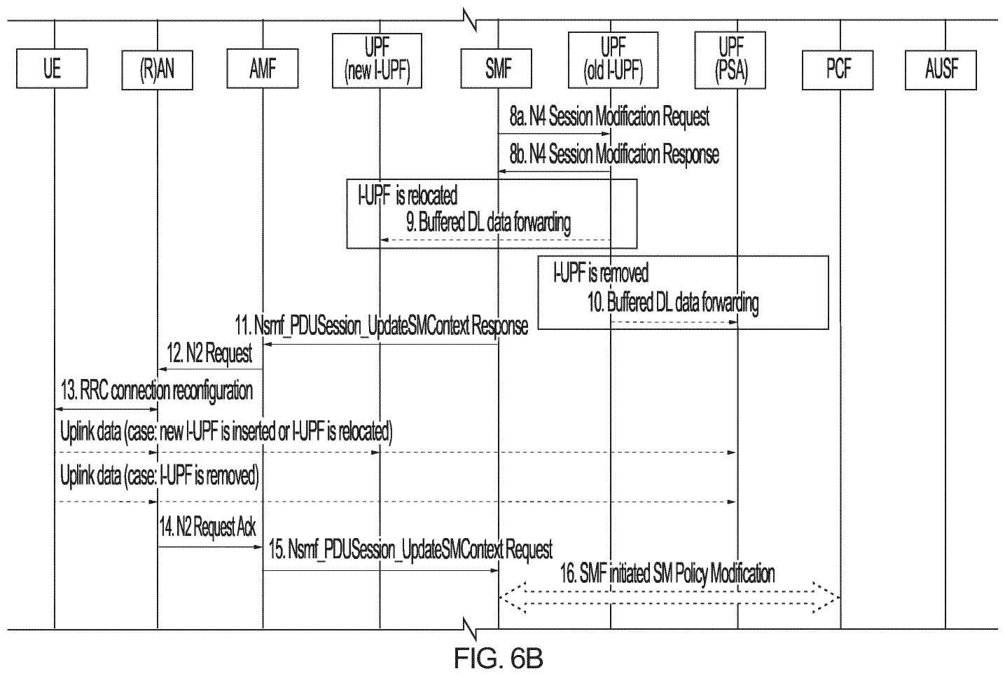

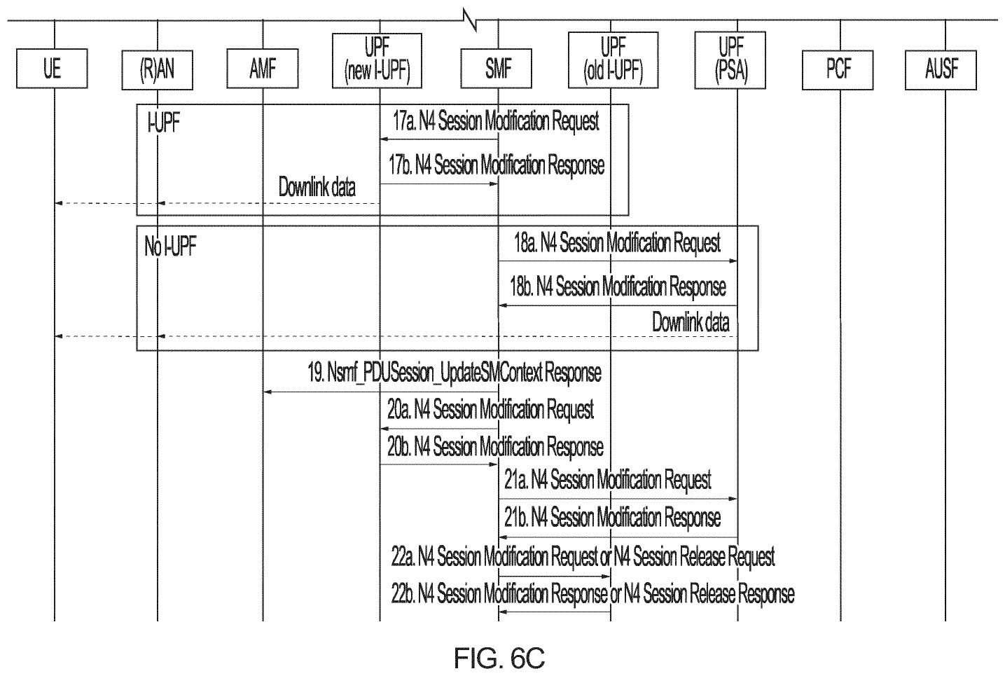

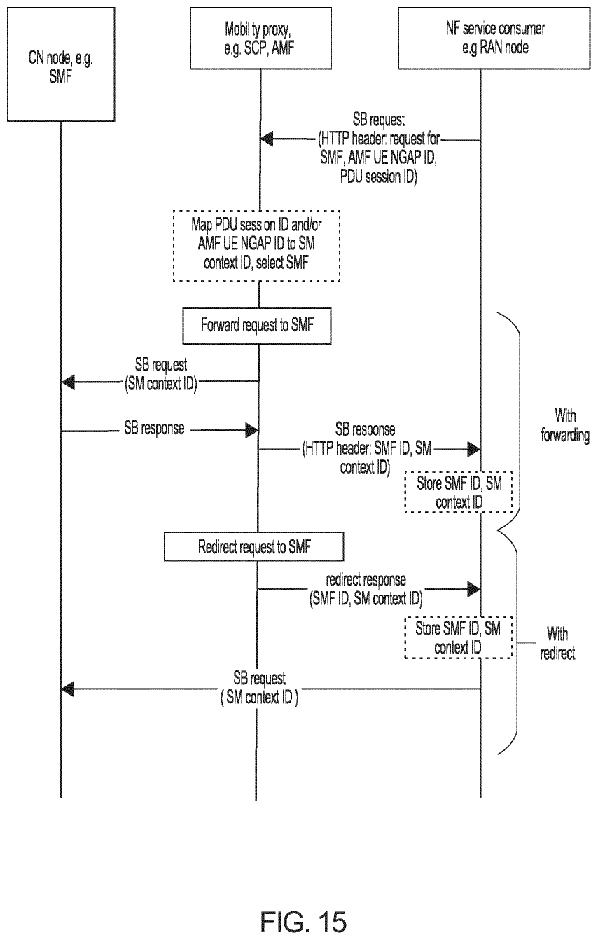

Mobility proxy has access to information about the identity (e.g. Address information, a node ID or a set ID) of core network node (e.g. SMF) serving a UE context or a PDU session, as identified by some UE identity (e.g. SUPI, AMF UE NGAP ID, GUTI) or by a PDU session identity and handles a HTTP request to be sent to the core network node serving a UE context or a PDU session. It determines the address of the core network (CN) node and either forwards or redirects the HTTP request towards that core network node.
The mobility proxy may be integrated in an AMF, an SCP, or a database holding to information on the identity of an CN node serving a UE context or PDU session.
The mobility proxy may interact with an AMF or a database holding information on CN node(s) serving a UE context or PDU session to retrieve information on the identity of the core network node(s) (e.g. SMF) serving a UE context or PDU session.
As shown in FIG. 15, when receiving a service-based request for a specific type of CN node and specific UE and possibly PDU session, the mobility proxy determines the CN node serving the UE and possible PDU session. The mobility proxy then either forwards the service request toward that CN, or it performs HTTP redirect to instruct the NF service consumer to forward the request to the CN node.
   In the request towards the CN node, the SM context ID may be part of the request URI.
In a variant, the mobility proxy provides a mapping from PDU session ID and UE IDs to SM contexts ID.
   The mobility proxy may interact with an AMF or a database holding information on SM contexts ID for PDU sessions IDs and UE IDs to retrieve the SM context ID.
To avoid that the mobility proxy needs to inspect message bodies, the information about UE identity (e.g. AMF UE NGAP ID) and possibly PDU session identity is preferably contained in an HTTP header.
For instance, the following PDU session related SB requests are candidates for such direct signaling from RAN node to CN node:
   N2 PDU Session Response and subsequent Nsmf_PDUSession_UpdateSMContext Request during PDU session establishment (messages 14 and 15 in 3GPP TS 23.502 FIG. 4.3.2.2.1-1, replicated in present FIG. 2), to be replaced by a Nsmf_PDUSession_UpdateSMContext Request
   N2 Path switch request and subsequent Nsmf_PDUSession_UpdateSMContext Request during Xn based handover (messages 1b and 2 in 3GPP TS 23.502 FIG. 4.9.1.2.2-1, replicated in present FIG. 3), to be replaced by a Nsmf_PDUSession_UpdateSMContext Request.
   Nsmf_PDUSession_UpdateSMContext Request during N2 based handover (message 7 in 3GPP TS 23.502 FIG. 4.9.1.3.3-1, replicated in present FIG. 5), to be sent directly by T-RAN rather than by T-AMF.
   Nsmf_PDUSession_UpdateSMContext Request during service request (message 4 in 3GPP TS 23.502 FIG. 4.2.3.2-1, replicated in present FIG. 6), to be sent directly by (R)AN rather than by AMF.
   N2 Response Ack and subsequent Nsmf_PDUSession_UpdateSMContext Request during Service activation (messages 14 and 15 in 3GPP TS 23.502 FIG. 4.2.3.2-1, replicated in present FIG. 6), to be replaced by a Nsmf_PDUSession_UpdateSMContext Request.

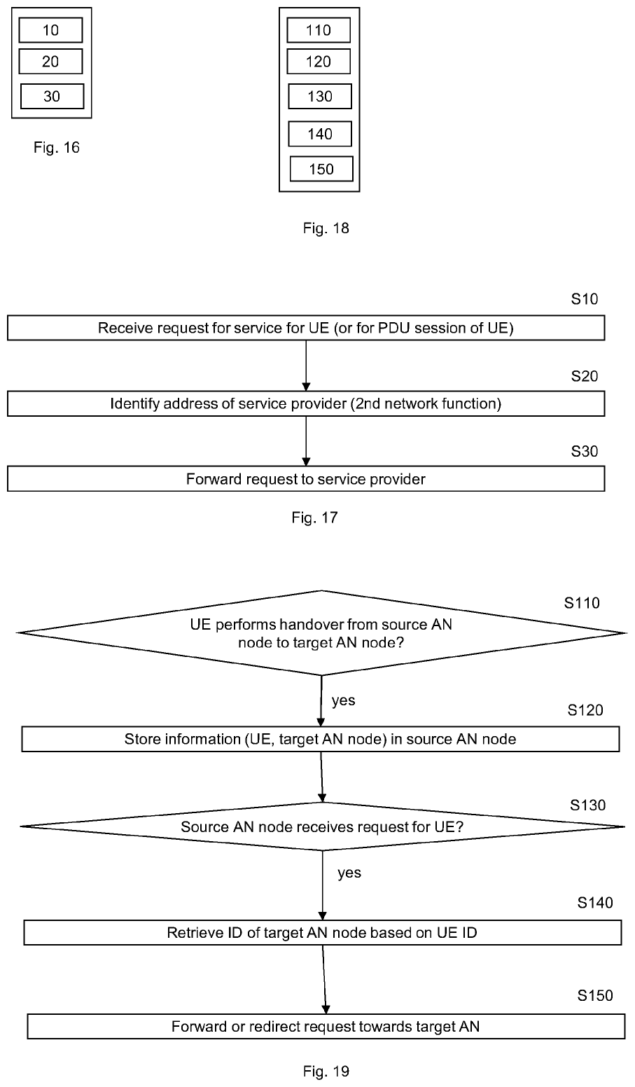

FIG. 16 shows an apparatus according to an example embodiment of the invention. The apparatus may be a proxy (such as a mobility proxy) or an element thereof. FIG. 17 shows a method according to an example embodiment of the invention. The apparatus according to FIG. 16 may perform the method of FIG. 17 but is not limited to this method. The method of FIG. 17 may be performed by the apparatus of FIG. 16 but is not limited to being performed by this apparatus.

The apparatus comprises means for receiving 10, means for identifying 20, and means for forwarding 30. The means for receiving 10, means for identifying 20, means for forwarding 30 may be a receiving means, identifying means, and forwarding means, respectively. The means for receiving 10, means for identifying 20, and means for forwarding 30 may be a receiver, identifier, and forwarder, respectively. The means for receiving 10, means for identifying 20, and means for forwarding 30 may be a receiving processor, identifying processor, and forwarding processor, respectively.

The means for receiving 10 receives, from a first network function of a first domain, a request for a service related to one of one or more terminals or to one or more PDU sessions of the one or more terminals (S10).

The means for identifying 20 identifies an address of one of one or more second network functions of a second domain based on the requested service, the one or more terminals and the one or more PDU sessions, respectively, and a mapping relationship (S20). The mapping relationship indicates, for each of the one or more terminals and for each of the one or more PDU sessions, respectively, a respective address of one of the one second network function.

The means for forwarding 30 forwards the request or redirects the request towards the one second network function (S30).

FIG. 18 shows an apparatus according to an example embodiment of the invention. The apparatus may be a base station (such as a gNB or eNB) or an element thereof. FIG. 19 shows a method according to an example embodiment of the invention. The apparatus according to FIG. 18 may perform the method of FIG. 19 but is not limited to this method. The method of FIG. 19 may be performed by the apparatus of FIG. 18 but is not limited to being performed by this apparatus.

The apparatus comprises means for monitoring 110, means for storing 120, means for supervising 130, means for retrieving 140, and means for forwarding 150. The means for monitoring 110, means for storing 120, means for supervising 130, means for retrieving 140, means for forwarding 150 may be a monitoring means, storing means, supervising means, retrieving means, and forwarding means, respectively. The means for monitoring 110, means for storing 120, means for supervising 130, means for retrieving 140, and means for forwarding 150 may be a monitor, storage device, supervisor, retriever, and forwarder, respectively. The means for monitoring 110, means for storing 120, means for supervising 130, means for retrieving 140, and means for forwarding 150 may be a monitoring processor, storing processor, supervising processor, retrieving processor, and forwarding processor, respectively.

The means for monitoring 110 monitors whether a terminal performs a handover from a source access node to a target access node (S110). If the terminal performs the handover (S110=yes), the means for storing 120 stores a pair of information in the source access node (S120). The pair of information comprises an identity of the terminal and an identity of the target access node.

The means for supervising 130 supervises whether the source access node receives a request for the terminal (S130). If the source access node receives the request for the terminal (S130=yes), the means for retrieving 140 retrieves the identity of the target access node based on the identity of the terminal (S140). The means for forwarding 150 forwards or redirects the request towards the target access node using the retrieved identity of the target access node (S150).

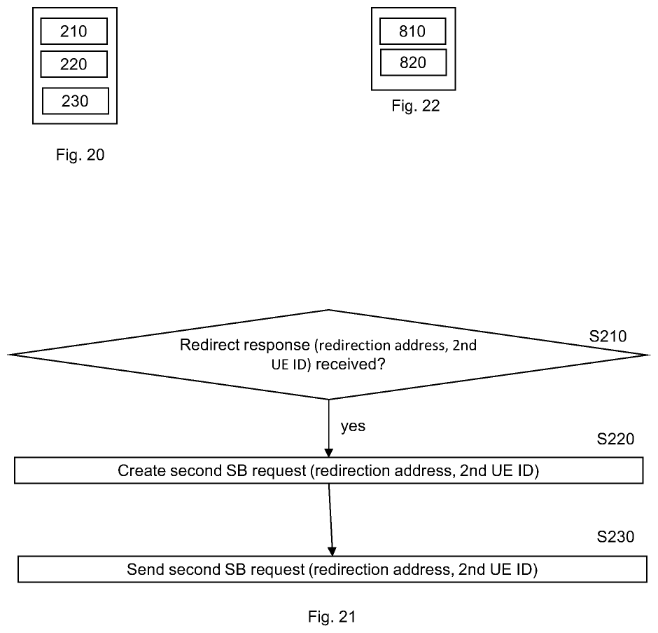

FIG. 20 shows an apparatus according to an example embodiment of the invention. The apparatus may be a service consumer or an element thereof. FIG. 21 shows a method according to an example embodiment of the invention. The apparatus according to FIG. 20 may perform the method of FIG. 21 but is not limited to this method. The method of FIG. 21 may be performed by the apparatus of FIG. 20 but is not limited to being performed by this apparatus.

The apparatus comprises means for monitoring 210, means for creating 220, and means for resending 230. The means for monitoring 210, means for creating 220, means for resending 230 may be a monitoring means, creating means, and resending means, respectively. The means for monitoring 210, means for creating 220, and means for resending 230 may be a monitor, creator, and resender, respectively. The means for monitoring 210, means for creating 220, and means for resending 230 may be a monitoring processor, creating processor, and resending processor, respectively.

The means for monitoring 210 monitors whether a redirect response is received in response to a first service based request sent to a terminal (S210). The first service based request comprises a first identity of the terminal, and the redirect response comprises a second identity of the terminal and a redirection address.

If the redirect response is received (S210=yes), the means for creating 220 creates a second service based request based on the first service based (S220). The second service based request is directed to the redirection address and comprises the second identity of the terminal. The means for resending 230 sends the second service based request to the redirection address (S230).

FIG. 22 shows an apparatus according to an embodiment of the invention. The apparatus comprises at least one processor 810, at least one memory 820 including computer program code, and the at least one processor 810, with the at least one memory 820 and the computer program code, being arranged to cause the apparatus to at least perform at least the method according to at least one of FIGS. 17, 19, and 21 and related description.

Some example embodiments are explained with respect to a 6G network. However, the invention is not limited to 6G. It may be used in other networks, too, e.g. in previous of forthcoming generations of 3GPP networks such as 4G, 5G, or 7G, etc. The invention is not even limited to mobile communication networks but may be applied anywhere where service provider and service consumer are located in different domains, such as CN and AN.

A terminal may be a UE, a MTC device, or any other device that may be served by the respective access network.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be deployed in the cloud.

According to the above description, it should thus be apparent that example embodiments of the present invention provide, for example, a proxy (such as a mobile proxy) or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a base station (such as a gNB or eNB) or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a service consumer or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Each of the entities described in the present description may be embodied in the cloud.

It is to be understood that what is described above is what is presently considered the preferred example embodiments of the present invention. However, it should be noted that the description of the preferred example embodiments is given by way of example only and that various modifications may be made without departing from the scope of the invention as defined by the appended claims.

1. An apparatus comprising:
one or more processors; and
memory storing instructions that, when executed by at least one of the one or more processors, cause the apparatus to perform operations, the operations comprising:
receiving, from a first network function of a first domain, a request for a first service related to one terminal of one or more terminals or related to one or more protocol data unit sessions of the one or more terminals;
identifying an address of one second network function of one or more second network functions of a second domain, the one or more terminals and the one or more protocol data unit sessions, respectively, and a first mapping relationship, wherein the first mapping relationship indicates, for each of the one or more terminals and for each of the one or more protocol data unit sessions of the one or more terminals, respectively, a respective address of the one second network function of the one or more second network functions that is capable of serving the one or more terminals or the one or more protocol data unit sessions of the one or more terminals;
forwarding the request or redirecting the request towards the one second network function.

2. The apparatus according to claim 1, wherein;
the first domain comprises an access network and the second domain comprises a core network; or
the first domain comprises the core network and the second domain comprises the access network.

3. The apparatus according to claim 1, wherein the operations further comprise:
retrieving the first mapping relationship from an access and mobility function of the first or the second domain.

4. The apparatus according to claim 1, wherein the redirecting comprises sending a redirect response to the request for the first service to the first network function, the redirect response comprising the address of the one second network function and an indication that the request is to be send towards the address of the one second network function.

5. The apparatus according to claim 4, wherein the operations further comprise:
checking whether the request comprises a first identifier of the one terminal;
based on the first identifier of the one terminal being comprised in the request, mapping the first identifier of the one terminal to a second identifier of the one terminal based on a second mapping relationship between one or more first identifiers and one or more second identifiers;
replacing, before the forwarding or the redirecting, the first identifier in the request with the second identifier; and
comprises the second identifier of the one terminal.

6. The apparatus according to claim 5, wherein the operations further comprise:
monitoring whether an identity change indication is received, wherein the identity change indication indicates that the first identifier of the one terminal is to be replaced by the second identifier of the one terminal;
storing the first identifier mapped to the second identifier in the second mapping relationship when the identity change indication is received.

7. The apparatus according to claim 5, wherein the operations further comprise:
assigning a new first identifier to the terminal;
storing the first identifier of the one terminal and the new first identifier of the one terminal within the second mapping relationship.

8. The apparatus according to claim 1, wherein the operations further comprise:
inhibiting the forwarding the request or the redirecting the request towards the one second network function when the first network function is not allowed to request the first service from the one second network function.

9. The apparatus according to claim 1, wherein the operations further comprise:
selecting one of the plural mapped addresses as the address of the one second network function when the first mapping relationship maps the addresses of the plural second network functions to the one terminal.

10. The apparatus according to claim 1, wherein the second domain comprises the access network and wherein the operations further comprise:
triggering paging of the one terminal when the one terminal has no signaling connection with the access network.

11. (canceled)

12. The apparatus according to claim 1, wherein the operations further comprise:
transferring a context for the one terminal to a third network function;
storing a third mapping relationship of the terminal and the third network function;
receiving, from the first network function, a request for a second service related to the one terminal of the one or more terminals
identifying an address of the third network function, the one terminal, and the third mapping relationship; and
forwarding the request for the second service or redirecting the request for the second service towards the third network function.

13. The apparatus according to claim 1, wherein
the second domain comprises the core network,
the request for the second service relates to one or more protocol data unit sessions of the one terminal,
each second network function of the one or more second network functions comprises a Session Management Function, and
the first mapping relationship indicates, for each of the one or more protocol data unit sessions of the one or more terminals, a respective address of a respective second network function of the one or more second network functions.

14. The apparatus according to claim 13, wherein the operations further comprise:
checking whether the request comprises an identifier of a protocol data unit session;
based on the request comprising the identifier of a protocol data unit session:
mapping the identifier of the protocol data unit session to a session management context identifier of the protocol data unit session based on a fourth mapping relationship between one or more protocol data unit session identifiers and one or more session management context identifiers;
including, before the forwarding or the redirecting, the session management context identifier of the protocol data unit session in the request; and
includes the session management context identifier.

15. (canceled)

16. (canceled)

17. An apparatus comprising:
one or more processors, and
memory storing instructions that, when executed by at least one of the one or more processors, cause the apparatus to perform operations, the operations comprising:
monitoring whether a redirect response that is received in response to a first service request sent to a terminal, wherein the first service request comprises a first identity of the terminal, and wherein the redirect response comprises a second identity of the terminal and a redirection address;
creating a second service request based on the first service request when the redirect response is received, wherein the second service request is directed to the redirection address and comprises the second identity of the terminal;
resending the second service request.

18. The apparatus according to claim 17, wherein the operations further comprise:
storing the second identity of the terminal when the redirect response is received.

19. A method comprising:
receiving, from a first network function of a first domain, a request for a first service related to one of one or more terminals or related to one or more protocol data unit sessions of the one or more terminals;
identifying an address of one second network function of one or more second network functions of a second domain, the one or more terminals and the one or more protocol data unit sessions, respectively, and a first mapping relationship, wherein the first mapping relationship indicates, for each of the one or more terminals and or for each of the one or more protocol data unit sessions of the one or more terminals, respectively, a respective address of the one second network function capable to serve the one or more terminals or the one or more protocol data unit sessions of the one or more terminals;
forwarding the request or redirecting the request towards the one second network function.

20. The method according to claim 19, wherein:
the first domain comprises an access network and the second domain comprises a core network; or
the first domain comprises the core network and the second domain comprises the access network.

21. The method according to claim 19, further comprising:
retrieving the first mapping relationship from an access and mobility function of the first or the second domain.

22. The method according to claim 19, wherein the redirecting comprises sending a redirect response to the request for the first service to the first network function, the redirect response comprising the address of the one second network function and an indication that the request is to be send towards the address of the one second network function.

23. The method according to claim 22, wherein further comprising:
checking whether the request comprises a first identifier of the one terminal;
based on the first identifier of the one terminal being comprised in the request, mapping the first identifier of the one terminal to a second identifier of the one terminal based on a second mapping relationship between one or more first identifiers and one or more second identifiers;
replacing the first identifier in the request with the second identifier; and
forwarding the request or redirecting the request comprises the second identifier of the one terminal.

24-38. (canceled)
